(19) United States
(12) Patent Application Publication
(10) Pub. No.: US 2025/0113203 A1
(43) Pub. Date: Apr. 3, 2025

(54) RESOLVING TN/NTN SPECTRUM CONFLICT BY ASSIGNMENT OF NON-OVERLAPPING CHANNELS

(71) Applicant: DISH Wireless L.L.C., Englewood, CO (US)

(72) Inventors: Jingyi Zhou, Belle Mead, NJ (US); Siddhartha Chenumolu, Ashburn, VA (US); Mehdi Alasti, Reston, VA (US)

(21) Appl. No.: 18/376,361

(22) Filed: Oct. 3, 2023

(51) Int. Cl. H04W 16/14; H04B 7/185; H04W 72/04

(52) U.S. Cl. CPC H04W 16/14; H04B 7/18513; H04W 72/04

(57) ABSTRACT

Methods and systems for operating a Non-Terrestrial Network (NTN) within geographic areas, and where a Terrestrial Network (TN) is also operating in at least one of the areas. A set of two or more candidate channels are selected for use by the NTN from spectrum allocated for use by the NTN which does not overlap with the channels allocated for use by the TN. The two or more channels may each specify a contiguous set of frequencies and timeslots. One of the candidate channels is assigned for use by the NTN as an active channel in a first one of the geographic areas, and another one of the candidate channels is assigned for use by the UEs as an active channel in a second one of the geographic areas.

### TECHNICAL FIELD

This patent relates to mobile wireless communication systems, and more particularly to techniques that resolve conflicts between spectrum utilization of terrestrial networks and non-terrestrial networks.

### BACKGROUND

The Third Generation Partnership Project (3GPP) Fifth Generation (5G) Working Group has specified a broad range of wireless services delivered across multiple access platforms and multi-layered networks to support a variety of end uses. 5G utilizes an intelligent Radio Access Network (RAN) architecture that is not constrained by the location of base stations or complex network infrastructure.

Non-Terrestrial Networks (NTN) are networks or segments of networks that use airborne or spaceborne platforms to deliver wireless connectivity. This technology can potentially revolutionize many industries, from agriculture to shipping, by providing reliable, high-speed wireless to previously unreachable areas.

Recent releases of the 3GPP's 5G standards recognize NTNs as a part of the 5G network infrastructure. Airborne or spaceborne 5G base stations can be launched and connected to terrestrial ground stations in a commercially feasible way. These high-altitude network segments maximize the inherent value of 5G networks by solving coverage problems and complex use cases that ground-based infrastructure alone cannot.

3GPP Release-17 first recognized the need for adjacent band coexistence between 5G New Radio (NR) Terrestrial Networks (TNs) and NR Non-Terrestrial Networks (NTNs). To that end, Release 17 introduced so-called Mobile Satellite Service (MSS) frequency bands to provide connectivity between 3GPP User Equipment (UE) directly with satellites, and which considers that their coexistence in adjacent bands with ground-based Terrestrial Networks (TNs) should be anticipated.

### SUMMARY OF PREFERRED EMBODIMENT(S)

In some aspects, the techniques described herein relate to a method or apparatus for operating a Non-Terrestrial Network (NTN) to cover two or more geographic areas and where a Terrestrial Network (TN) is also operating in at least one of the areas. The methods and apparatus described herein facilitate operation of NTNs and TNs and provides a solution for adjacent band coexistence and also avoids overlapping spectrum utilization.

Candidate channels are selected for use by the NTN from portions of the electromagnetic spectrum allocated for use by the NTN which do not overlap with the channels allocated for use by the TN. Each candidate channel may include a set of radio frequencies allocated for communication between the NTN and User Equipment (UEs).

One of the candidate channels is assigned for use by the NTN as an active channel in a first one of the geographic areas, and another candidate channel is also assigned for use by the UEs as an active channel in a second one of the geographic areas.

When movement of a selected one of the UEs from the first geographic area to the second geographic area is detected, a gNodeB (gNB) operating in the NTN may command a UE to switch its assigned active channel. This may be performed using intra-frequency or inter-frequency handover mechanism.

The assignment of active channels to geographic areas may be considered to be static in that such assignments to each geographic area, once any potential overlap is determined, need not change unless the channels allocated to either the TN or NTN change.

The active channels may be further selected from the set of candidate channels to (a) maximize at least one of throughput, channel quality, or signal strength of the NTN; (b) minimize out-of-band interference between the TN and NTN, and/or (c) minimize intra-NTN-band handover interference when one of UEs moves from one geographic area to another geographic area.

The candidate channels assigned for use as the active channel(s) may also be selected by i) mapping two or more of the UEs to the one of the set of candidate channels having the largest bandwidth, or by ii) distributing two or more of the set of candidate channels to two or more of the UEs, based on the respective bandwidths of the two or more of the set of candidate channels.

When a selected UE is located near a border of the first one of the geographic areas, the active channels of the second one of the areas may be assigned from a non-active list of the selected UE with the same portion of spectrum allocated to the NTN.

When a selected UE is moving from the first geographic area to the second geographic area, and the portion of the spectrum allocated to the NTN are the same for the first and second geographic areas, then an intra-frequency handover process maybe used to switch the selected UE to a new active channel. Otherwise, switching the selected UE to a new active channel can involve an inter-frequency handover process so that the UE operates within a channel in a different portion of the NTN spectrum.

The geographic area of the cells that make up the NTN may have a different shape or different dimension than the cells that make up the TN.

The active channels may be assigned from a “super”-NTN spectrum portion that includes contiguous and/or non-contiguous parts of the electromagnetic spectrum allocated for both the TN and NTN.

In some aspects, the techniques described herein relate to an apparatus for operating a Non-Terrestrial Network (NTN) to cover two or more geographic areas, and where a Terrestrial Network (TN) is also operating in at least one of the geographic areas. Such an apparatus may include one or more data processors, and one or more computer-readable media, the computer-readable media including instructions that, when executed by the one or more data processors, cause the one or more data processors to perform a process.

The process may include determining active channels in use by the TN, determining a set of two or more candidate channels for use by the NTN from areas of the electromagnetic spectrum that are allocated for use by the NTN, and which electromagnetic spectrum does not overlap with the channels allocated for use by the TN. The two or more candidate channels may each specify a contiguous set of frequencies available for communication between the NTN and two or more User Equipments (UEs) operating within the two or more geographic areas. One of the set of candidate channels may be assigned for use by the NTN as an active channel for the UEs to communicate using the NTN in a first one of the geographic areas. Another one of the set candidate channels may be assigned for use by the UEs as an active channel for the UEs to communicate using the NTN in a second one of the geographic areas.

### BRIEF DESCRIPTION OF THE DRAWINGS

Features and advantages of the approaches discussed herein are evident from the text that follows and the accompanying drawings, where:

FIG. 1 shows an example Terrestrial Network (TN) 100 and Non-Terrestrial Network (TN) 120 operating simultaneously in a given geographic area to provide wireless service to User Equipments (UEs) 170.

FIG. 2 illustrates an example of the TN 100 and NTN 120 spectrum allocations for ITU Region 2.

FIG. 3 illustrates a situation for NTN channel n255 within the L-band uplink from 1626.5-1660.5 MHz and downlink from 1525-1559 MHz.

FIG. 4 illustrates an example satellite with a multi-beam antenna used in the NTN.

FIG. 5 is an example flowchart of the steps that may be carried out by Spectrum Management 180.

FIG. 6A shows a Super NTN spectrum 600 overlapping with six channels assigned to the TN 100.

FIG. 6B shows spectrum assignments for a first coverage area where TN channels TN: f1 and TN: f2 and an NTN spectrum region G1 are active.

FIG. 6C shows a second coverage area with three active TN channels and active NTN spectrum region G2.

FIG. 7 illustrates how assignment of NTN spectrum and/or channels may change as UEs move from area to area.

FIG. 8 is a flow diagram for assignment of NTN spectrum and channels as UEs move from area to area.

### DETAILED DESCRIPTION OF PREFERRED EMBODIMENT(S)

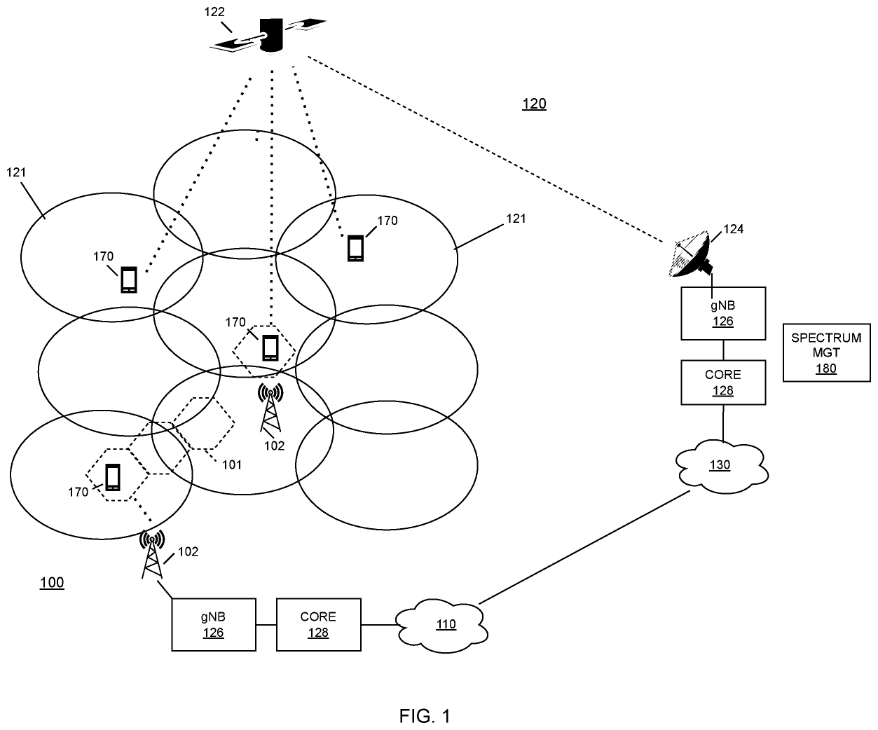

FIG. 1 shows an example scenario where a Terrestrial Network (TN) 100 and a Non-Terrestrial Network (TN) 120 are operating simultaneously in a given geographic area to provide wireless service to User Equipments (UEs) 170.

The TN 100 can refer specifically to a New Radio (NR) implementation as specified by the Third Generation Partnership Project (3GPP) Fifth Generation (5G) Working Group. The TN 100 uses terrestrial antennas 102 and a 5G Radio Access Nodes (RAN) 105 including a 3GPP Next Generation Node B (gNB or gNodeB) 106 to service UEs 170 located in a cell or coverage area 101. 5G core functions 108 provide connectivity between the UEs 170 and a data network 110. Data network 110 can represent one or more public and/or private networks. For example, data network 110 can include the Internet. However, data network 110 may also include a private communication network of a communications service provider.

The NTN 120 services UEs 170 via a space-borne platform such as a Low Earth Orbiting (LEO) satellite 122. The NTN 120 may be enabled by other types of platforms such as Medium Earth Orbit (MEO) and Geostationary Earth Orbit (GEO) satellites, and can also include High Altitude Platform Systems (HAPS) and other airborne or space-borne systems.

The NTN 120 can refer specifically to a 5G New Radio (NR) implementation. In such an embodiment, the NTN 120 implements a 5G Radio Access Node 125, including an NTN gateway 124 and gNB 126. The NTN 120 also includes a 5G core 128 to provide connectivity to a data network 130. Data network 130 can represent one or more public and/or private networks. Data networks 110 and 130 may be the same network, or they may each include one or more interconnected data networks.

The gNB 106, 126 and 5G core 108, 128 components can be controlled together or independently and can be deployed on either physical data processing machines (e.g. as small cell hardware) or as virtual machines running on dedicated servers, as shared cloud resources, or some combination thereof.

One aspect of the control of the gNB 126 and core 128 of the NTN 120 is Spectrum Management 180. Particular functions of Spectrum Management 180 will be discussed in more detail below. Spectrum Management 180 can be deployed on either physical data processing machines (e.g. as small cell hardware) or as virtual machines running on dedicated servers, as shared cloud resources, or some combination thereof.

The UEs 170 represent various forms of mobile wireless devices that can communicate using the TN 100 and/or NTN 120. For example, any combination of mobile phones, smartphones, cellular modems, personal computers, wireless sensors, access points (APs), gaming devices, Internet of Things (IoT) devices, and any other 5G-equipped device may function as UEs 170.

FIG. 1 shows specific logical nodes as singular elements, but in many instances, each logical node is provided for or connected in plural. For example, the NTN 120 may include several satellite platforms 122, and the TN 100 may include a number of terrestrial stations 102. In a typical system, thousands of UEs 170 may be present in a particular area. Thus any given TN 100 or NTN 120 may be communicating with many UEs 170. There also may be a mix of UEs 170 that can communicate with only a TN 100 or only with an NTN 120; however, some UES may be capable of communicating with both the TN 100 and NTN 120.

In a scenario of interest, the NTN 120 operates within electromagnetic spectrum according to a regulation or specification. As one example, 3GPP TR 38.863 specifically contemplates the co-existence of 5G NR Non-Terrestrial Networks (NTNs) with overlaid Terrestrial Networks (TNs) for providing Mobile Satellite Service (MSS). Depending on the International Telecommunications Union (ITU) regulations specific to a particular geographic region, there can be partial or even complete overlap between the bands assigned to the TNs 100 and the bands assigned to the NTNs 120.

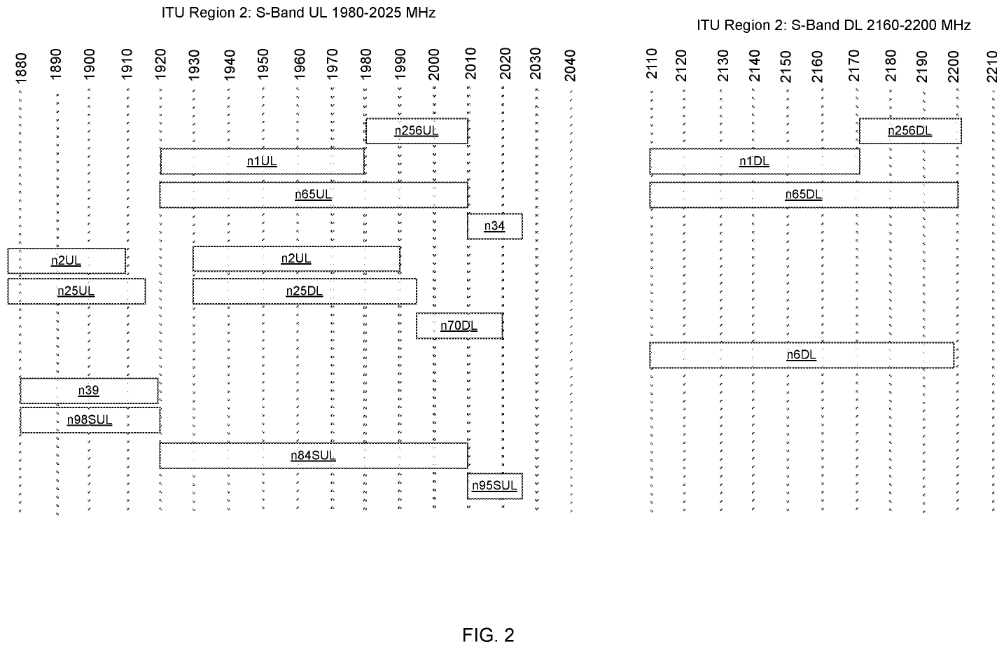

FIG. 2 illustrates an example of the TN 100 and NTN 120 spectrum allocations for ITU Region 2. The NTN channel labeled “n256” is allocated for uplink (UL) in the S-band from 1980-2010 MHz, and n256 is also allocated for downlink (DL) within the S-Band from 2170-2200 MHz. Note that there are several possibly active TN channels (n1, n65, etc.) near, and some of these overlap the NTN channels. Also note within the UL band that NTN channel n256 is fully overlapped by TN n65 UL and partly overlapped by TN n2 DL, n25 DL, and n70 DL. For the downlink direction, the n256 NTN channel is fully overlapped by TN n65 and n66 and partially overlapped by TN DL n1.

This limits NTN n256 deployment to regions where TN n2, n25, n65, n66, and/or n70 are not deployed. However, deployment of NTN n256 is possible where other non-overlapping TN bands such as n25, n39, n84, and n98 are active. Note also that the NTN n256 UL channel is adjacent to, but not overlapping, TN n1 (FDD) and n34 (TDD). These additional TN channels can be active if they are protected from NTN interference.

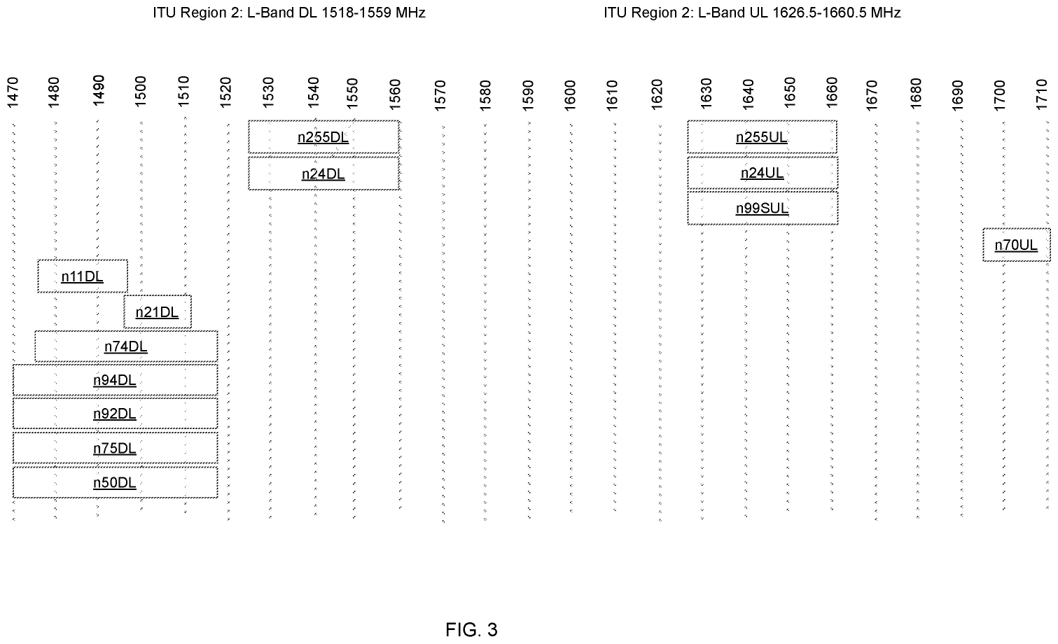

FIG. 3 illustrates a similar situation for NTN channel n255 within the L-band UL from 1626.5-1660.5 MHz and DL from 1525-1559 MHz. Here, NTN n255 is fully overlapped by TN NR n24 on the downlink. On the uplink, NTN n255 is overlapped by TN NR bands n24 and n99. Also, the NTN band n255 fully overlaps with TN NR bands n24 and n99.

Therefore, it is possible for NTN and TN networks to overlap and operate within the same area simultaneously. However, this requires active channel assignments to be coordinated based on these regulatory constraints.

The problem of the NTN channels being active in a particular geographic area and potentially overlapping with active TN channels in the same area can be solved by coordinated assignment and switching of the channels assigned for use by UEs operating within the NTN 120 as the UEs 170 and/or satellite stations 122 move between geographic areas.

More particularly, the channels assigned for communication within the different areas serviced by the NTN 120 may typically be assigned from portions of the spectrum where there is no overlap between the TN 100 and NTN 120. Once the channels allocated for use by the TN and channels allocated for use by the NTN are known in a particular geographic area, the non-overlapping areas of spectrum do not typically change. Thus, knowing these allocations to the TN and NTN, channels that are assigned for active use by the NTN may be fixed (or “static”) until such time as a change occurs in the frequency allocation plan for either the TN or NTN (or both).

Spectrum Management 180 may thus coordinate the use of a specific section of the spectrum for use by the NTN 120 that does not overlap with spectrum used by the TN 100. Returning attention briefly to FIG. 1, Spectrum Management 180 may accomplish this by ensuring that a given UE 170 operating within the NTN only uses frequencies that are not actively assigned to the TN in the same area. This may be implemented by transmitting active channel information from Spectrum Management 180 to the gNB 126 and then from the gNB 126 to the UEs 170. An intra-frequency or inter-frequency handover mechanism may be used along with conditional handover depending on the location of the UE.

The functionality of Spectrum Management 180 may be incorporated partially or wholly within or coordinated by 5G core 128 or coordinated with or wholly within at one or more components of the RAN 125, such as the gNBs 126. Spectrum Management 180 may also communicate via network 130 and/or 110 to coordinate channel assignments so that it is aware of the channels currently active with the TNs 100 operating in the same or neighboring geographic areas as the NTN 120.

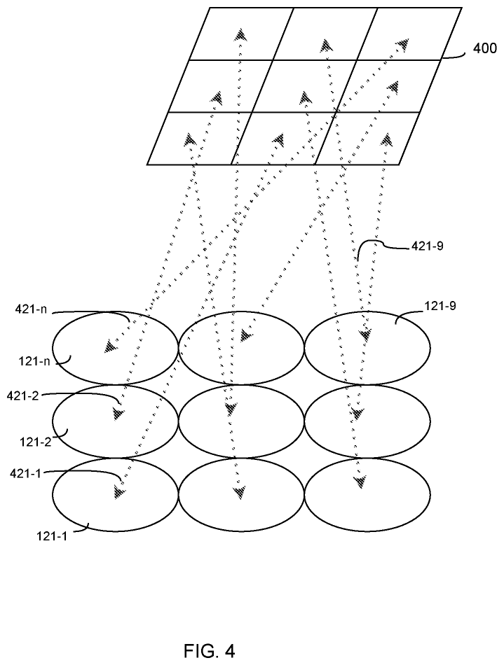

In the systems described herein, the satellite stations 122 implementing the NTN 120 may utilize directional beamforming antennas. As shown in FIG. 4, a beamforming antenna 400, in effect operates as a set of small antennas, each serving a particular geographic area 121 independently of other areas. In this example, nine (9) beams 421-1, 421-2, . . . , 421-9 each serve a respective geographic area 121-1, 121-2, . . . , 121-9. Each generated beam can also operate within its assigned NTN channel(s). The NTN 120 can use the beamforming antenna array 400 to transmit and receive signals only over the non-overlapping spectrum dedicated to the NTN channel in a given area 121-n. As a result, the NTN signals originating from other UEs in the geographical areas other than 121-n will be rejected by the beamforming antenna array 400. This approach also allows the satellite to coordinate the use of the best available non-overlapping channel.

Returning attention briefly to FIG. 1, recall that the area 121, served by a given NTN beam is not necessarily the same size or shape as the area 101 serviced by a given terrestrial antenna 102 or TN 100. Also germane here is that when a NTN antenna beam is present in an area 121 where there is overlap with a TN channel, the NTN 121 is configured to only broadcast channel within bands where there is no overlap with the overlaid TN area 101.

It should also be understood that a given beamforming antenna 400 operating on a satellite 122 may be shared between wireless service providers. For example, one set of beams channel may be dedicated to a first operator, such as a Mobile Network Operator (MNO) such as Verizon; another set of beams channel assigned to a Virtual MNO, such as Dish, and a third set of beams channel assigned to support a private wireless operator such as General Motors.

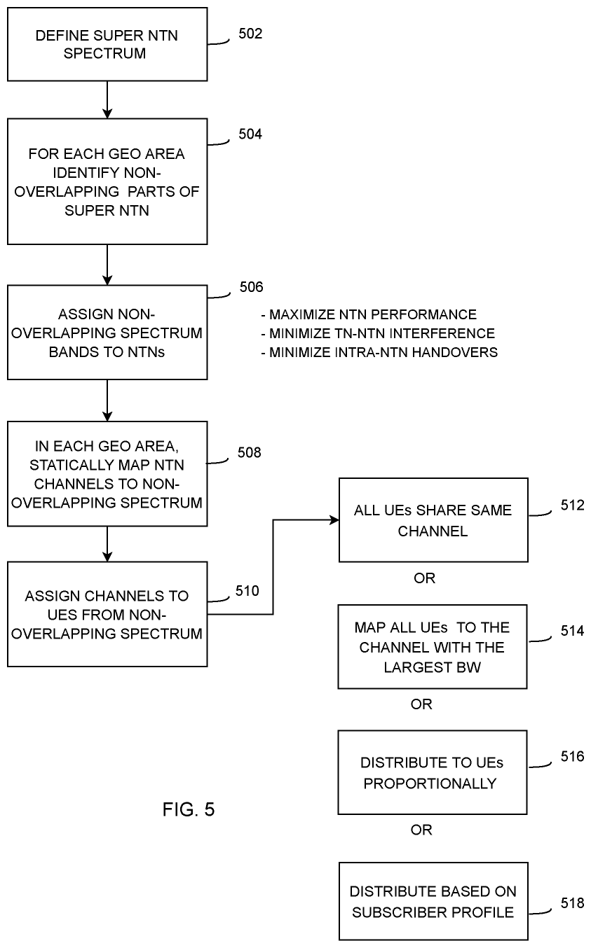

FIG. 5 is an example flowchart of the steps that may be carried out by Spectrum Management 180.

First, in state 502, a Super NTN band is defined as a collection of contiguous and/or non-contiguous spectrum that includes TN channels assigned to a geographic region.

Next, in state 504, regions of the NTN spectrum that do not overlap with active TN channels are identified for each area serviced by the NTN 120. Candidate channels for use by the NTN within these spectrum regions are also identified that have no overlap with the TN channels assigned to each area.

As part of state 506, Spectrum Management 180 may further assign those regions of the NTN spectrum (and hence specific channels within those spectrum regions) which meet one or more criteria, such as
(a) maximizing NTN performance (throughput, channel quality or signal strength, etc.),
(b) minimizing TN-NTN out-of-band interference, and/or
(c) minimizing intra-NTN-band handover for the UEs crossing one area to another area.

In state 508, for each geographic area serviced by the NTN, one or more available channels with that area's assigned NTN spectrum region are allocated as a set of candidate channels. This assignment of candidate NTN channels to geographic areas may be considered to be static in that such assignments, once any potential spectrum overlap is determined, need not change unless the spectrum and/or channels allocated to either the TN or NTN change.

In state 510, at some point later in time, one or more UEs request access to the NTN.

If there is only one available NTN channel in the area, then in state 512 all of the UEs in that area are mapped to that single available channel.

However, if there are multiple channels are available within the non-overlapping spectrum in a given area, then different schemes can be used to distribute these channels to different UEs. These can include:
i. mapping all UEs to the active channel with the largest bandwidth (state 514); or
ii. Distributing channels to UEs proportionally, based on the respective bandwidths of the available channels (state 516). For example, if there are two possible channels of 10 MHz and 5 MHZ, then ⅔rds of the UEs are mapped to the 10 MHz channel, and the remaining ⅓rd are mapped to the 5 MHz channel; or
iii. Distributing the channels to UEs based on a profile of the UEs. For example, certain UEs may have paid for a premium service that offers greater throughput than other UEs (state 518).

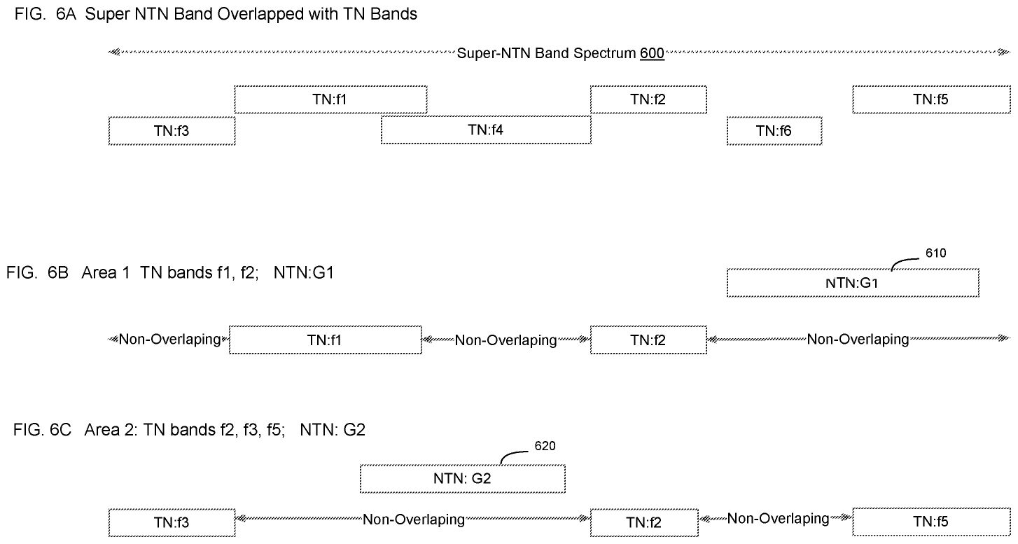

FIG. 6A, 6B and 6C illustrate how Spectrum Management 180 may allocate channels from the non-overlapping spectrum regions available to the NTN 120.

Per FIG. 6A, this can be implemented by defining a “Super” NTN band 600 as a collection of contiguous or and/or non-contiguous spectrum that encompasses the spectrum assigned to both the TN and NTN. The exact extent of the Super NTN band 600 may depend on which portions of the band are permitted for use by the TN channels (in this example, TN: f1, TN: f2, . . . . TN: f6) in the ITU region of interest (which may include the S-band).

In the example of FIG. 6B, the TNs in a particular geographic area (“Area 1”) are assigned to use channels “TN: f1” and “TN: f2”. Channels TN: f1 and TN: f2 may be selected the TN channels defined by the ITU S-band plan for the region (recall that FIGS. 2 and 3 illustrated some example TN channels for ITU Region 2).

Thus for Area 1, a first region of NTN spectrum that does not overlap any TN channel exists below TN: f1, a second non-overlapping spectrum region is between TN: f1 and TN: f2, and a third non-overlapping spectrum region is above TN: f2. The third non-overlapping NTN region can be assigned by Spectrum Management 180 to be an NTN spectrum region call “G1” and made available in Area 1.

As shown in FIG. 6C, the active TN channels in an example adjacent geographic area (“Area 2”) include TN: f2, TN: f3, and TN: f5. The non-overlapping spectrum region between TN: f2 and TN: f3 can be allocated as spectrum region G2 available for assignment to the NTN 120 in Area 2.

In this example, the NTN spectrum regions allocated to these two respective different geographical areas (e.g., Area 1 and Area 2) encompass different respective spectrum regions G1 and D2. However, in other situations the two different geographic areas may each use the same spectrum region.

It should be understood additional NTN spectrum regions G3, G4, etc. can be similarly identified and assigned if there are additional sections of non-overlapping spectrum in a given geographic area.

As mentioned previously, the shape, size, and alignment of the cells operated by the TN 100 are likely different from the shape, size, and alignment of the beams operated by the NTN 120. For example, coverage of a TN may typically be a market, such as city and the suburban areas around it. Such a market usually includes a collection of many TN cells. On the other hand, an NTN beam may cover a very large area that could be even larger than a single TN market covered by a single satellite beam. In other scenarios, a single NTN beam may only cover a part of a very large TN market. Thus, the regions of “non-overlapping spectrum” between a given TN 100 and NTN 120 may not precisely follow the defined coverage areas of either the TN 100 or the NTN 120.

Consideration should also be given to the fact that certain satellites 122 are Non-Geostationary Orbit (NGSO) satellites that move across the sky over time. Therefore the geographic areas served by a particular satellite and its several beams and even the ITU regions serviced may also change over time. As a result, the assigned NTN spectrum regions for a particular satellite may change over time to accommodate such satellite movement.

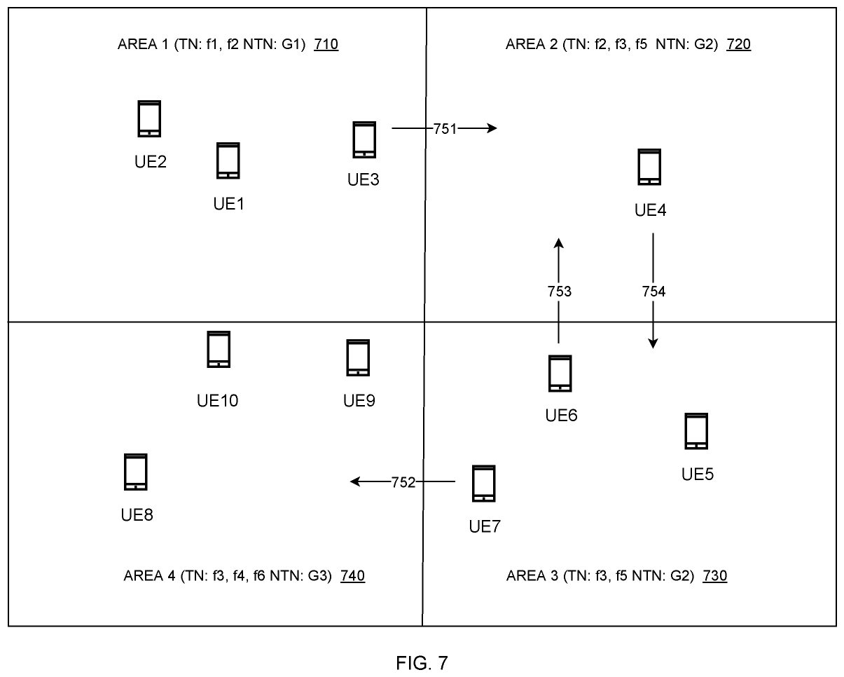

FIG. 7 illustrates how channels within the allocated NTN spectrum may be assigned to the UEs operating in adjacent coverage areas. In this example, within a first coverage area (“Area 1”) 710, channels TN: f1 and TN: f2 are active for the TN and spectrum region G1 has been allocated for use by the NTN.

FIG. 7 also shows that for a second coverage area (“Area 2”) 712, there are three active TN channels—TN: f2, TN: f3, and TN: f5. Spectrum region G2 is allocated for use by the NTN 120 in Area 2.

For Area 3 730, TN channels TN: f3 and TN: f5 are active. G2 has been allocated to the NTN 120 in this area, which is the same region of the NTN spectrum assigned for use by Area 2 702.

Area 4 740 has active TN channels TN: f3, TN: f4, and TN: f6, and a non-overlapping region of the Super NTN band, G3, has been identified for use by the NTN 120.

In this example, user equipment UE1, UE2 and UE3 are active within Area 1 710, UE4 is active in Area 2 720, UE8, UE9 and UE10 are active in Area 3 730, and UE5, UE6 and UE7 are active within Area 4 740.

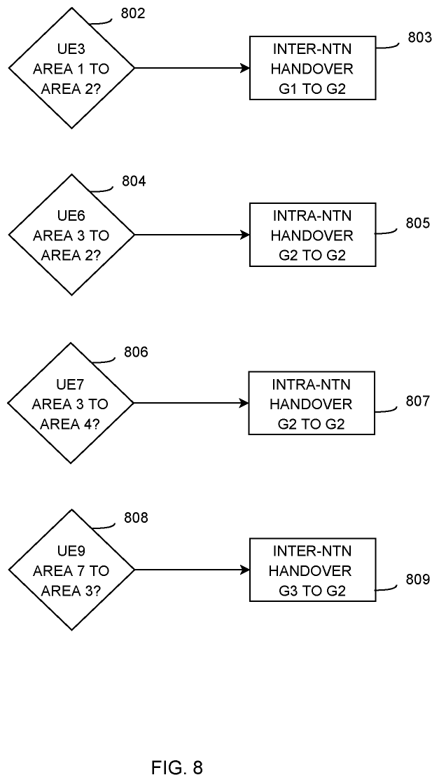

Referring now to the flow of FIG. 8 while continuing to refer to FIG. 7, management of specific NTN channels from the perspective of the UEs as they move from area to area will be explained.

In state 802 of FIG. 8, when UE3 moves from Area 1 710 to Area 2 720 (indicated by arrow 751 in FIG. 7), Spectrum Management 180 sends a command to UE3 in state 803 to switch from operating on a channel within spectrum region G1 to operate on a channel within G2. This is a type of inter-frequency handover, that is, when a UE moves to a different area and switches to operate within a different NTN band. Such a handover may utilize 3GPP Release 17 conditional handover (CHO) mechanism.

State 804 occurs when UE6 moves from area 2 to area 3 (indicated by arrow 753. Here UE3 was already operating within G2. State 805 can thus effect an intra-frequency handover, where the UE continues to operate within the same NTN band that it has been (G2) while switching to a different channel within G2. Such an intra-frequency handover may be accomplished by the gNBs utilizing the 3GPP Release 17 CHO mechanism.

Similarly, in state 806 when UE4 moves from Area 2 to Area 3 (indicated by arrow 754), the same NTN spectrum region can be reused and an intra-frequency handover is possible in state 807.

However, in state 808 when UE7 moves from Area 3 to Area 4 (arrow 752), Spectrum Management 180 switches UE7 from operating on a channel within G2 to a channel within G3. Thus an inter-frequency handover is needed in state 809.

It can now be understood how the channels assigned for use by an NTN are selected from portions of the Super NTN spectrum that do not overlap with active channel assignments for TNs in the same area. Different channels may also be assigned to neighboring coverage areas of the NTN that use the same allocated region of the Super NTN spectrum.

### Further Implementation Options

It will be appreciated by those of skill in the art that various options are possible for implementing the functions and components described herein.

The UEs 170, satellite 122, gateway 124, and RANs 105, 125, respectively include one or more transceivers, which may be any type of device configured to transmit and/or receive radio frequency signals via one or more antennas. The transceivers may perform coding, decoding, modulation, and demodulation of data.

The UEs 170, satellite 122, gateway 124, RANs 105, 125, gNBs 106, 126, and cores 108, and 128 may also be implemented in whole or in part as data processors. These processors may be a controller, a microcontroller, a microprocessor, or a microcomputer and may be implemented by hardware, firmware, software, or their combination. Application-specific integrated circuits (ASICs), digital signal processors (DSPs), digital signal processing devices (DSPDs), programmable logic devices (PLDs), and field programmable gate arrays (FPGAs). These devices are configured to perform the techniques described herein.

In some instances, the data processors may be implemented in whole or in part by a physical or virtual, or cloud-based general-purpose computer having a central processor, memory, disk or other mass storage, communication interface(s), input/output (I/O) device(s), and other peripherals. The general-purpose computer is transformed into the processor and executes the processes described above, for example, by loading software instructions into the processor and then causing execution of the instructions to carry out the functions described.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read-only memory (ROM); random access memory (RAM); storage including magnetic disk storage media; optical storage media; flash memory devices; and others.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

This disclosure is also not limited by the name of each node described above, and in the case of a logical node or entity performing the above-described function, the configuration of this disclosure may be applied. In addition, the different logical nodes may be physically located in the same or different physical location as other logical nodes, and may be provided with a function by the same physical device (e.g., a processor, a controller, etc.) or by another physical device. As an example, the function of at least one logical node described herein may be provided through virtualization in one physical device.

The methods, systems, and devices discussed above should be considered to be examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional states or steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may then execute the program code to perform the described tasks.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

The above description has particularly shown and described example embodiments. However, it will be understood by those skilled in the art that various changes in form and details may be made therein without departing from the legal scope of this patent as encompassed by the appended claims.

1. A method of operating a Non-Terrestrial Network (NTN) to cover two or more geographic areas, and where a Terrestrial Network (TN) is also operating in at least one of the geographic areas, the method comprising:
determining channels that are allocated for use by the TN;
determining a set of two or more candidate channels for use by the NTN from areas of electromagnetic spectrum that are allocated for use by the NTN and which electromagnetic spectrum does not overlap with the channels allocated for use by the TN, the two or more candidate channels each specifying one or more frequencies available for communication between the NTN and two or more User Equipments (UEs) operating within the two or more geographic areas;
assigning one of the set of candidate channels for use by the NTN as an active channel for the UEs to communicate using the NTN in a first one of the geographic areas; and
assigning one of the set of candidate channels for use by the UEs as an active channel for the UEs to communicate using the NTN in a second one of the geographic areas.

2. The method of claim 1 additionally comprising:
assigning one or more of the candidate channels for use by the NTN as one or more non-active channels in the first one of the geographic areas, such that at least one of the non-active channels is the same as the active channel assigned to the second one of the geographic areas.

3. The method of claim 2 additionally comprising:
at a gNodeB operating within the NTN,
receiving information regarding movement of a selected one of the UEs from the first geographic area to the second geographic area; and
transmitting an instruction to the selected one of the UEs to switch its assigned active channel.

4. The method of claim 3 wherein transmitting an instruction further comprises:
using information from UEs for conditional handover for intra-frequency or inter-frequency handovers.

5. The method of claim 1 wherein determining the set of two or more candidate channels for use by the NTN in a geographic area is static, such that the set of two or more candidate channels is only changed when portions of the electromagnetic spectrum allocated to the NTN or allocated to the TN channel.

6. The method of claim 1 wherein at least one of the active channels is further assigned to:
(a) maximize at least one of throughput, channel quality or signal strength of the NTN;
(b) minimize out of band interference between the TN and NTN, and/or
(c) minimize intra-NTN-band handover interference when one of UEs moves from one geographic area to another geographic area.

7. The method of claim 1 wherein assigning one of the set of candidate channels for use as the active channel for the UEs to communicate using the NTN in the first one of the geographic areas further comprises:
i. mapping two or more of the UEs to the one of the set of candidate channels having largest bandwidth; or
ii. distributing two or more of the set of candidate channels to two or more of the UEs, based on the respective bandwidths of the two or more of the set of candidate channels.

8. The method of claim 1 additionally comprising:
determining when a selected UE is located near a border of the first one of the geographic areas, and then assigning the active channels of the second one of the areas to a non-active list of the selected UE.

9. The method of claim 2 additionally comprising:
at a gNodeB operating within the NTN,
receiving information regarding movement of a selected UE from the first geographic area to the second geographic area;
when the active channels of the first and second geographic areas are the same, then:
(a) not switching the selected UE to a new active channel; and
(b) effecting an intra-frequency handover such that the UE operates within a different portion of the active channel; and
Otherwise:
(c) switching the selected UE to a new active channel that corresponds to at least one of the non-active channels; and
(d) effecting an inter-frequency handover such that the UE operates within a portion of the new active channel.

10. The method of claim 1 wherein the channels are assigned from a super-NTN spectrum that includes parts of the electromagnetic spectrum allocated for both the TN and NTN in at least one of the geographic areas.

11. An apparatus for operating a Non-Terrestrial Network (NTN) to cover two or more geographic areas, and where a Terrestrial Network (TN) is also operating in at least one of the geographic areas, the apparatus comprising:
one or more data processors; and
one or more computer readable media including instructions that, when executed by the one or more data processors, cause the one or more data processors to perform a process for:
determining channels that are allocated for use by the TN;
determining a set of two or more candidate channels for use by the NTN from areas of electromagnetic spectrum that are allocated for use by the NTN and which electromagnetic spectrum does not overlap with the channels allocated for use by the TN, the two or more candidate channels each specifying one or more frequencies available for communication between the NTN and two or more User Equipments (UEs) operating within the two or more geographic areas;
assigning one of the set of candidate channels for use by the NTN as an active channel for the UEs to communicate using the NTN in a first one of the geographic areas; and
assigning one of the set of candidate channels for use by the UEs as an active channel for the UEs to communicate using the NTN in a second one of the geographic areas.

12. The apparatus of claim 11 wherein the one or more data processors are further for:
assigning one or more of the candidate channels for use by the NTN as one or more non-active channels in the first one of the geographic areas, such that at least one of the non-active channels is the same as the active channel assigned to the second one of the geographic areas.

13. The apparatus of claim 12 wherein the one or more data processors are further for:
at a gNodeB operating within the NTN,
receiving information regarding movement of a selected one of the UEs from the first geographic area to the second geographic area; and
transmitting an instruction to the selected one of the UEs to switch its assigned active channel.

14. The apparatus of claim 13 wherein transmitting an instruction further comprises:
using information from the UEs for conditional handover for intra-frequency or inter-frequency handovers.

15. The apparatus of claim 11 wherein determining the set of two or more candidate channels for use by the NTN in a geographic area is static, such that the set of two or more candidate channels is only changed when portions of the electromagnetic spectrum allocated to the NTN or allocated to the TN channel.

16. The apparatus of claim 11 wherein at least one of the active channels is further assigned to:
(a) maximize at least one of throughput, channel quality or signal strength of the NTN;
(b) minimize out of band interference between the TN and NTN, and/or
(c) minimize intra-NTN-band handover interference when one of UEs moves from one geographic area to another geographic area.

17. The method of claim 11 wherein assigning one of the set of candidate channels for use as the active channel for the UEs to communicate using the NTN in the first one of the geographic areas further comprises:
i. mapping two or more of the UEs to the one of the set of candidate channels having largest bandwidth; or
ii. distributing two or more of the set of candidate channels to two or more of the UEs, based on the respective bandwidths of the two or more of the set of candidate channels.

18. The apparatus of claim 11 wherein in the one or more data processors are further for:
determining when a selected UE is located near a border of the first one of the geographic areas, and then assigning the active channels of the second one of the areas to a non-active list of the selected UE.

19. The apparatus of claim 12 wherein the one or more data processors are further for:
at a gNodeB operating within the NTN,
receiving information regarding movement of a selected UE from the first geographic area to the second geographic area;
when the active channels of the first and second geographic areas are the same, then:
(a) not switching the selected UE to a new active channel; and
(b) effecting an intra-frequency handover such that the UE operates within a different portion of the active channel; and
otherwise:
(c) switching the selected UE to a new active channel that corresponds to at least one of the non-active channels; and
(d) effecting an inter-frequency handover such that the UE operates within a portion of the new active channel.

20. The apparatus of claim 11 wherein one or more data processors are further for:
assigning candidate channels from a super-NTN spectrum that includes parts of the electromagnetic spectrum allocated for both the TN and NTN in at least one of the geographic areas.
